(19) United States
(12) Patent Application Publication
(10) Pub. No.: US 2025/0155196 A1
(43) Pub. Date: May 15, 2025

(54) HEAT TREATMENT SYSTEM

(71) Applicant: NGK INSULATORS, LTD., Nagoya-Shi (JP)

(72) Inventors: Yuya TANAKA, Nagoya-Shi (JP); Akinobu KOURA, Nagoya-Shi (JP); Takeshi KOMAKI, Nagoya-Shi (JP)

(73) Assignee: NGK INSULATORS, LTD., Nagoya-Shi (JP)

(21) Appl. No.: 18/731,606

(22) Filed: Jun. 3, 2024

(30) Foreign Application Priority Data
Nov. 9, 2023 (JP) 2023-191519

(51) Int. Cl. F27B 9/20

(52) U.S. Cl. CPC F27B 9/207; F27B 9/208

(57) ABSTRACT

A heat treatment system may include: a heat treatment furnace including an entrance, an exit, and an internal space in which a plurality of saggars is conveyed from the entrance to the exit; and a return line located outside the heat treatment furnace and configured to convey the plurality of saggars from the exit to the entrance. The return line may include: a first conveying device located in a first section and configured to convey the plurality of saggars; and a second conveying device located in a second section different from the first section and configured to convey the plurality of saggars by a beam or a bar.

### REFERENCE TO RELATED APPLICATIONS

This application claims priority to Japanese Patent Application No. 2023-191519, filed on Nov. 9, 2023, the entire contents of which are hereby incorporated by reference into the present application.

### TECHNICAL FIELD

The disclosure herewith relates to a heat treatment system.

### BACKGROUND ART

Japanese Patent No. 7041300 describes a heat treatment system. The heat treatment system includes a heat treatment furnace having an internal space in which a plurality of saggars is conveyed from an entrance to an exit, and a return line located outside the heat treatment furnace and configured to convey the plurality of saggars from the exit to the entrance. The return line conveys the plurality of saggars using a roller conveyor and a chain conveyor.

### SUMMARY

In the heat treatment system above, while conveyed on the roller conveyor and the chain conveyor in a conveying direction, the saggars are in close contact with each other in a conveying direction. Thus, the orientation of the saggars may change during conveyance. Further, on the return line, various operations are performed, such as supplying a pre-heat-treated material into empty saggars, etc. For these operations, the saggars need to be separated apart from each other in the conveying direction and be oriented in a predetermined direction. If at least one of separating the saggars apart from each other in the conveying direction and adjusting the orientations of the saggars is performed at a position where the above-mentioned operations are performed on the saggars or performed immediately before the above-mentioned operations are performed on the saggars, it takes time to convey the saggars on the return line.

The disclosure herein provides a technology that allows for a reduction in time to convey saggars.

In a first aspect of the technology disclosed herein, a heat treatment system may comprise: a heat treatment furnace including an entrance, an exit, and an internal space in which a plurality of saggars is conveyed from the entrance to the exit; and a return line located outside the heat treatment furnace and configured to convey the plurality of saggars from the exit to the entrance. The return line may comprise: a first conveying device located in a first section and configured to convey the plurality of saggars; and a second conveying device located in a second section different from the first section and configured to convey the plurality of saggars by a beam or a bar.

In the configuration above, the second conveying device conveys the saggars by the beam or the bar, which suppresses changes in the orientations of the saggars while the saggars are conveyed. Therefore, it is not required to adjust the orientations of the saggars at a predetermined position (e.g., in the second section) within the return line. Further, since the second conveying device conveys the plurality of saggars by the beam or the bar, the saggars can be maintained apart from each other by a certain distance. Therefore, the time required to convey the saggars can be reduced.

### BRIEF DESCRIPTION OF DRAWINGS

FIG. 1 schematically shows a heat treatment system according to a first embodiment.

FIG. 2 schematically shows a disintegrating device according to the first embodiment.

FIG. 3 schematically shows a recovery device according to the first embodiment.

FIG. 4 schematically shows a cleaning device according to the first embodiment.

FIG. 5 schematically shows a filling device according to the first embodiment.

FIG. 6 schematically shows a surface smoothing device according to the first embodiment.

FIG. 7 shows a top view illustrating a saggar on a stand and a saggar on a second upstream roller conveyor in the heat treatment system according to the first embodiment.

FIG. 8 shows a side view illustrating a saggar on the stand and a saggar on a first upstream roller conveyor in the heat treatment system according to the first embodiment.

FIG. 9 shows a side view illustrating a stopper positioned at a second position in the heat treatment system according to the first embodiment.

FIG. 10 shows a top view illustrating a saggar on the stand and a saggar on the first upstream roller conveyor in the heat treatment system according to the first embodiment.

FIG. 11 shows a side view illustrating saggars on a moving device before the moving device moves in a conveying direction in the heat treatment system according to the first embodiment.

FIG. 12 shows a side view illustrating saggars on the moving device after the moving device has moved in the conveying direction in the heat treatment system according to the first embodiment.

FIG. 13 shows a side view illustrating a saggar on a first downstream roller conveyor and a saggar on the stand in the heat treatment system according to the first embodiment.

FIG. 14 schematically shows a heat treatment system according to a second embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved heat treatment systems, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a second aspect of the technology disclosed herein according to the first aspect, the heat treatment system may further comprise a processing device located in the second section and configured to process saggars being conveyed by the second conveying device. The second conveying device may comprise a moving device configured to: allow the plurality of saggars aligned in a conveying direction to be placed thereon, and be movable in the conveying direction, in a backward direction opposite to the conveying direction, in an up direction perpendicular to the conveying direction, and in a down direction opposite to the up direction. This configuration does not require the saggars to be adjusted in orientation for the processing by the processing device. Therefore, the time required to convey the saggars can be reduced.

In a third aspect of the technology disclosed herein according to the second aspect, the heat treatment system may further comprise a stand on which a saggar to be processed by the processing device is placed. The moving device may be configured to move the saggar onto the stand when moving in the conveying direction, the up direction, and the down direction. This configuration does not require the saggar on the stand to be adjusted in orientation before processed. Therefore, the time required to convey the saggar can be reduced.

In a fourth aspect of the technology disclosed herein according to the third aspect, the first conveying device may comprise: an upstream conveyor located upstream of the second conveying device on the return line; and a downstream conveyor located downstream of the second conveying device on the return line. The moving device may be configured to move a saggar conveyed on the upstream conveyor onto the stand and move the saggar on the stand to the downstream conveyor when moving in the conveying direction, the up direction, and the down direction. In this configuration, the saggar on the upstream conveyor is moved onto the stand at the same time the saggar on the stand is moved onto the downstream conveyor. Therefore, the time required to convey the saggars can be reduced.

In a fifth aspect of the technology disclosed herein according to the fourth aspect, the heat treatment system may further comprise an orientation adjusting device configured to adjust orientations of the saggars on the upstream conveyor. In this configuration, when a saggar is moved from the upstream conveyor onto the stand, the orientation of the saggar has already been adjusted.

In a sixth aspect of the technology disclosed herein according to any one of the second to fourth aspects, the processing device may be selected from a group consisting of: a cleaning device configured to clean the saggars, a filling device configured to fill the saggars with a material, and a surface smoothing device configured to smooth a surface of a material in the saggars. Generally, the orientations of saggars need to be adjusted for processing by a cleaning device, a filling device, and a surface smoothing device in order to reduce variation in the processing results among the saggars. In the configuration above, adjustment of saggar's orientation is not required and distance between saggars can be maintained regardless of whether the processing device is the cleaning device, the filling device, or the surface smoothing device. Therefore, the time required to convey the saggars can be reduced.

### First Embodiment

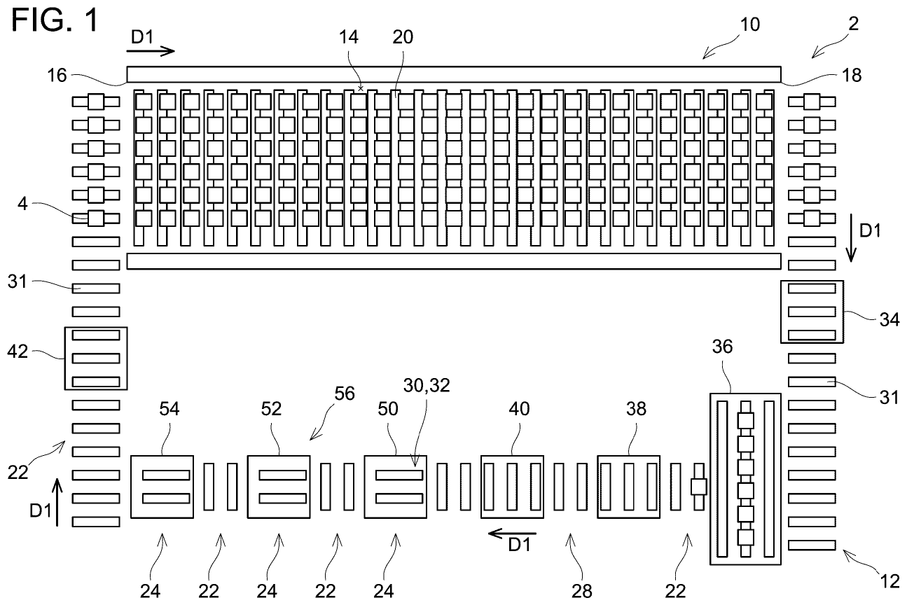

As shown in FIG. 1, a heat treatment system 2 comprises a heat treatment furnace 10 and a return line 12.

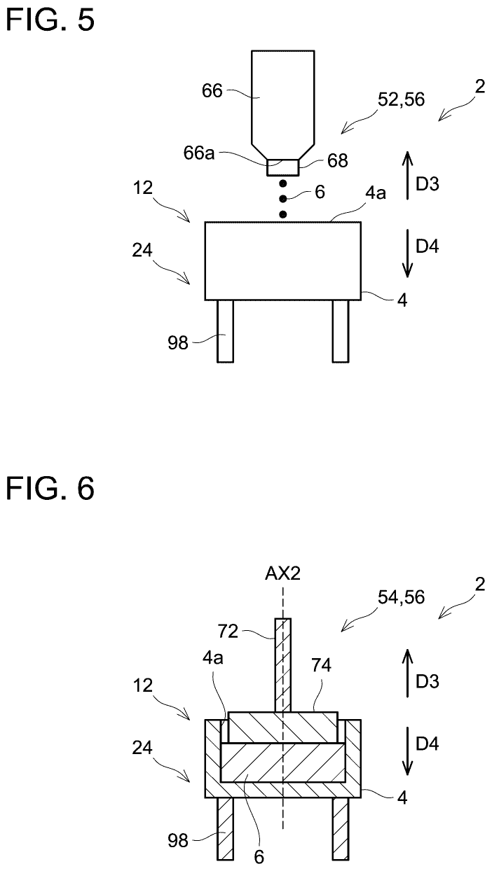

The heat treatment furnace 10 fires, i.e., heat-treats a material 6 (see FIG. 5) in saggars 4. The material 6 is for example a raw material for a ceramic capacitor, a positive-electrode material or a negative-electrode material of a lithium-ion battery.

The heat treatment furnace 10 is a heat insulating structure having a substantially cuboid shape. The heat treatment furnace 10 includes an internal space 14 therein. The heat treatment furnace 10 further includes an entrance 16 positioned at one end of the heat treatment furnace 10 and an exit 18 positioned at another end of the heat treatment furnace 10. The internal space 14 communicates with the outside of the heat treatment furnace 10 through the entrance 16 and the exit 18. Stacks of the saggars 4 are conveyed by rollers 20 within the internal space 14 in a conveying direction D1. The saggars 4 are thus conveyed from the entrance 16 to the exit 18.

The return line 12 is located outside the heat treatment furnace 10. The return line 12 conveys the saggars 4 from the exit 18 to the entrance 16 in the conveying direction D1.

The return line 12 comprises a plurality of first sections 22 (four first sections 22 in this embodiment) and a plurality of second sections 24 (three second sections 24 in this embodiment). The first sections 22 and the second sections 24 are arranged alternately. Each of the entrance 16 and the exit 18 of the heat treatment furnace 10 is connected to corresponding one of the first sections 22.

The return line 12 comprises first conveying devices 28 and second conveying devices 30. Each of the first conveying devices 28 is located in corresponding one of the first sections 22. Each first conveying device 28 comprises a plurality of rollers 31, and both ends of each roller 31 are rotatably supported. The saggars 4 are conveyed on the rollers 31 in the conveying direction D1 by rotation of the rollers 31. The second conveying devices 30 each comprise a moving device 32. For example, the saggars 4 are conveyed by the moving devices 32 in the conveying direction D1 by walking beam conveyance. Details of the moving devices 32 and how the saggars 4 are conveyed will be described later.

The heat treatment system 2 comprises an unstacking device 34, a cooling device 36, a disintegrating device 38, a recovery device 40, and a stacking device 42. The unstacking device 34, the cooling device 36, the disintegrating device 38, the recovery device 40, and the stacking device 42 are positioned in the first sections 22. The unstacking device 34, the cooling device 36, the disintegrating device 38, the recovery device 40, and the stacking device 42 are arranged in this order from an upstream end of the return line 12 toward a downstream end thereof. The unstacking device 34, the cooling device 36, the disintegrating device 38, and the recovery device 40 are positioned upstream of the most upstream-side second section 24. The stacking device 42 is positioned downstream of the most downstream-side second section 24.

The unstacking device 34 unstacks the stacks of saggars 4 stacked in an up-down direction to unstacked individual saggars 4 after the stacks of saggars 4 are conveyed out from the exit 18. From here on, the saggars 4 are conveyed in a line in the conveying direction D1. The up-down direction is substantially perpendicular to the conveying direction D1.

The cooling device 36 is configured to allow the saggars 4 to pass therethrough. The cooling device 36 cools the saggars 4 and the material 6 in the saggars 4 using a cooling medium (e.g., air, water, etc.) flowing through at least one cooling pipe (not shown).

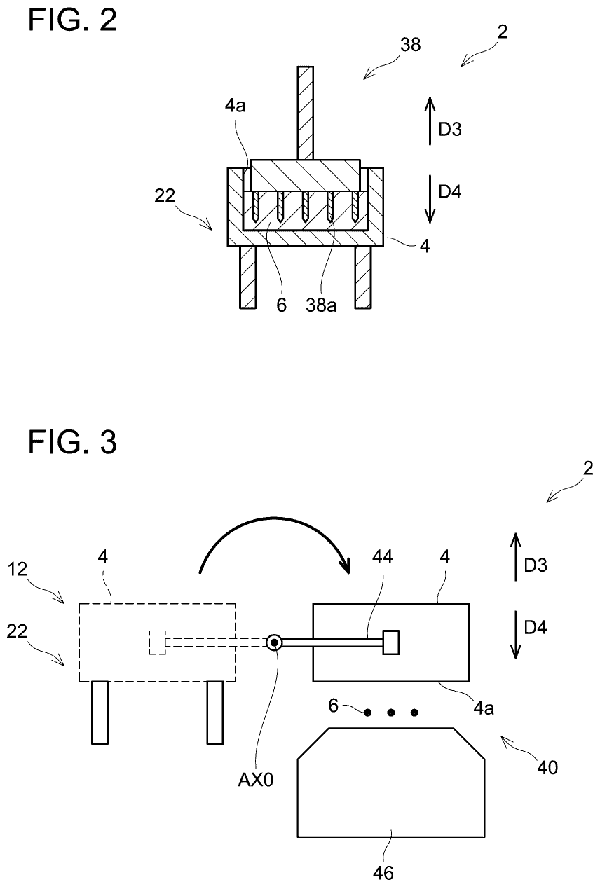

As shown in FIG. 2, the disintegrating device 38 comprises one or more pins 38a. The one or more pins 38a are thrusted into the material 6 in the saggars 4, thereby disintegrating the material 6.

As shown in FIG. 3, the recovery device 40 comprises a reverser 44 and a recovery container 46. The reverser 44 grips a saggar 4 and turns it upside down by rotating about a rotation axis AX0. An opening 4a of the saggar 4 is thereby oriented downward, and the material 6 is recovered into the recovery container 46 from the saggar 4.

As shown in FIG. 1, the stacking device 42 stacks the saggars 4 in the up-down direction. The stacks of saggars 4 are then conveyed to the entrance 16.

The heat treatment system 2 further comprises a cleaning device 50, a filling device 52, and a surface smoothing device 54. The cleaning device 50, the filling device 52, and the surface smoothing device 54 are positioned in the second sections 24. The cleaning device 50, the filling device 52, and the surface smoothing device 54 are arranged in this order from the upstream end of the return line 12 toward the downstream end thereof. The cleaning device 50, the filling device 52, and the surface smoothing device 54 are arranged between the recovery device 40 and the stacking device 42. The cleaning device 50 is positioned in the most upstream-side second section 24 among the three second sections 24. The filling device 52 is positioned in the middle second section 24 among the three second sections 24. The surface smoothing device 54 is positioned in the most downstream-side second section 24 among the three second sections 24. A first section 22 is positioned between the cleaning device 50 and the filling device 52, and another first section 22 is positioned between the filling device 52 and the surface smoothing device 54. Hereinafter, the cleaning device 50, the filling device 52, and the surface smoothing device 54 may be each termed a processing device 56.

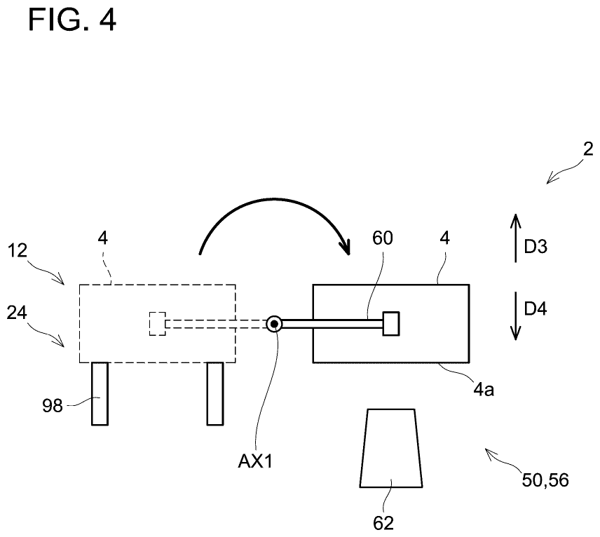

As shown in FIG. 4, the cleaning device 50 comprises a reverser 60 and a cleaner 62. The reverser 60 grips a saggar 4 and turns it upside down by rotating about a rotation axis AX1.

The cleaner 62 is positioned so as to face the saggar 4 reversed by the reverser 60 in the up-down direction. The cleaner 62 discharges a gas upward toward the opening 4a of the saggar 4, thereby removing the material 6 remaining in the saggar 4 from the saggar 4.

As shown in FIG. 5, the filling device 52 comprises a container 66 and a supplier 68. The container 66 stores a pre-firing material 6 with which the saggars 4 to be filled.

The supplier 68 is connected to an outlet 66a of the container 66. The supplier 68 supplies a predetermined amount of the material 6 into a saggar 4 through the opening 4a, thereby filling the saggar 4 with the pre-firing material 6.

As shown in FIG. 6, the surface smoothing device 54 comprises a rotation shaft 72 and a vane 74. The rotation shaft 72 rotates about an axis AX2.

The vane 74 is connected to the rotation shaft 72. The vane 74 rotates about the axis AX2 as the rotation shaft 72 rotates, thereby smoothing the surface of the material 6 in a saggar 4.

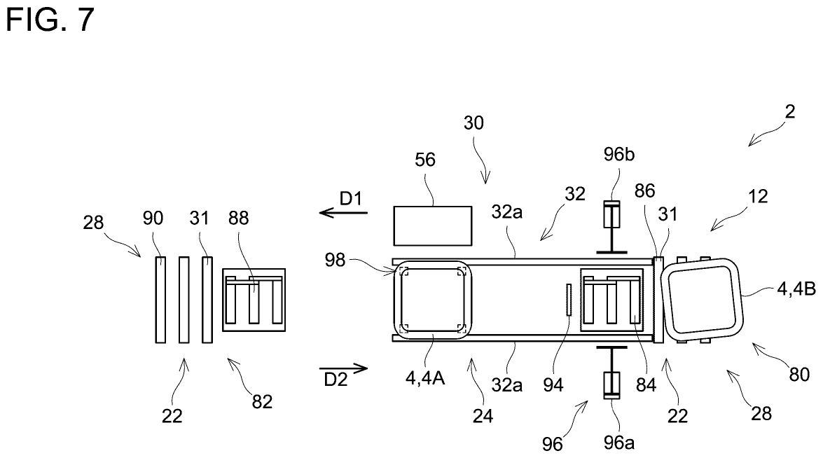

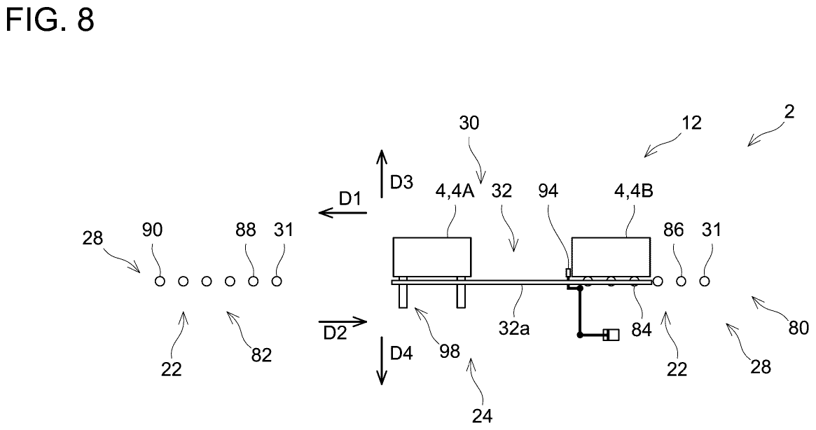

As shown in FIGS. 7 and 8, each moving device 32 is positioned in corresponding one of the second sections 24. Each moving device 32 is positioned between adjacent first sections 22. Each moving device 32 comprises two beams (or bars) 32a. The beams 32a are elongated in the conveying direction D1. A length of the beams 32a in the conveying direction D1 is equal to or more than 2.5 times a length of the saggars 4 in the conveying direction D1. Thus, the moving device 32 (i.e., the beams 32a) is configured to allow multiple saggars 4 to be placed thereon. The length of the beams 32a in the conveying direction D1 may be equal to or more than three times the length of the saggars 4 in the conveying direction D1. Further, the length of the beams 32a in the conveying direction D1 may be equal to or less than four times the length of the saggars 4 in the conveying direction D1. The beams 32a are configured to be moved by an actuator (not shown) in the conveying direction D1, in a backward direction D2 opposite to the conveying direction D1, in an up direction D3 substantially perpendicular to the conveying direction D1, and in a down direction D4 opposite to the up direction D3.

Each first conveying device 28 comprises an upstream roller conveyor 80 and a downstream roller conveyor 82. Each upstream roller conveyor 80 and each downstream roller conveyor 82 comprises a plurality of rollers 31. Each upstream roller conveyor 80 is positioned upstream of a corresponding one of the moving devices 32 on the return line 12. Each downstream roller conveyor 82 is positioned downstream of corresponding one of the moving devices 32 on the return line 12.

Each upstream roller conveyor 80 comprises a first upstream roller conveyor 84 and a second upstream roller conveyor 86. The first upstream roller conveyor 84 is positioned downstream of the second upstream roller conveyor 86 on the return line 12. The first upstream roller conveyor 84 is positioned between the moving device 32 and the second upstream roller conveyor 86. A width of the first upstream roller conveyor 84 is smaller than an interval between the two beams (bars) 32a.

Each downstream roller conveyor 82 comprises a first downstream roller conveyor 88 and a second downstream roller conveyor 90. The first downstream roller conveyor 88 is positioned upstream of the second downstream roller conveyor 90 on the return line 12. The first downstream roller conveyor 88 is positioned between the moving device 32 and the second downstream roller conveyor 90. A width of the first downstream roller conveyor 88 is smaller than the interval between the two beams (bars) 32a.

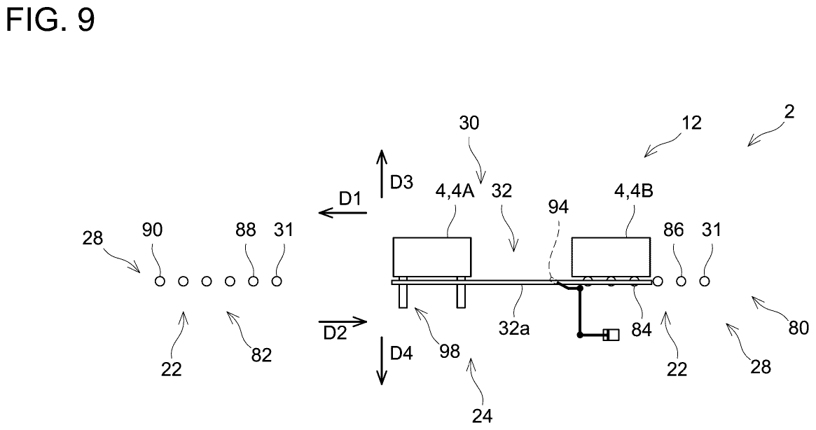

The heat treatment system 2 further comprises stoppers 94, orientation adjusting devices 96, and stands 98. Each of the stoppers 94 is positioned downstream of corresponding one of the first upstream roller conveyors 84 on the return line 12. Each stopper 94 switches between a first position (see FIG. 8) and a second position (see FIG. 9). As shown in FIG. 8, at the first position, the stopper 94 contacts a saggar 4 on the first upstream roller conveyor 84, thereby stopping the saggar 4 on the first upstream roller conveyor 84. This prevents the saggar 4 from deviating off of the first upstream roller conveyor 84. As shown in FIG. 9, the second position is below the first position (see FIG. 8). At the second position, the stopper 94 does not contact a saggar 4 on the first upstream roller conveyor 84.

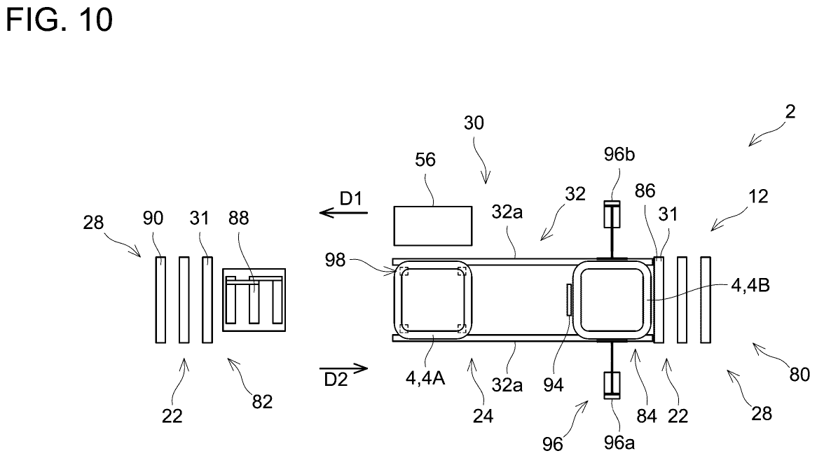

As shown in FIG. 10, each orientation adjusting device 96 is positioned in corresponding one of the first sections 22. Each orientation adjusting device 96 comprises a first pusher 96a and a second pusher 96b. Each first upstream roller conveyor 84 is interposed between corresponding first pusher 96a and second pusher 96b. A saggar 4 on the first upstream roller conveyor 84 is held between the first pusher 96a and the second pusher 96b by the first pusher 96a and the second pusher 96b moving closer to each other. The orientation of the saggar 4 on the first upstream roller conveyor 84 is thereby adjusted.

Each stand 98 is positioned in corresponding one of the second sections 24. The stand 98 is positioned near a processing device 56. The stopper 94 is positioned between the stand 98 and the first upstream roller conveyor 84. Each stand 98 is configured to allow one saggar 4 to be placed thereon. The saggar 4 on each stand 98 is processed by the processing device 56. Specifically, as shown in FIGS. 4 to 6, the saggar 4 on the stand 98 (see FIG. 10) is cleaned by the cleaning device 50 and is then filled with the material 6 by the filling device 52, and the surface of the material 6 in the saggar 4 on the stand 98 is smoothed by the surface smoothing device 54.

FIGS. 7 to 13 illustrate how multiple saggars 4 are moved by a moving device 32 from an upstream roller conveyor 80 to a downstream roller conveyor 82. In the initial state, one saggar 4 is on the stand 98 and another saggar 4 is conveyed on the upstream roller conveyor 80. In this state, the stopper 94 is at the first position. Hereinafter, one of the saggars 4 is termed a saggar 4A and the other is termed a saggar 4B.

As shown in FIG. 7, the saggar 4A on the stand 98 is processed by the processing device 56. While the saggar 4A is processed, the saggar 4B is moved on the upstream roller conveyor 80 from the second upstream roller conveyor 86 to the first upstream roller conveyor 84 by the rotation of the rollers 31. Thereafter, as shown in FIG. 8, the saggar 4B contacts the stopper 94 at the first position.

After the rollers 31 stop rotating, the first pusher 96a and the second pusher 96b move closer to each other, as shown in FIG. 10, thereby adjusting the orientation of the saggar 4B on the first upstream roller conveyor 84. Since the orientation of the saggar 4B on the first upstream roller conveyor 84 is adjusted while the saggar 4A is processed by the processing device 56, the time required to convey the saggars 4 is reduced.

After the processing device 56 completes the processing on the saggar 4A, the stopper 94 moves from the first position to the second position, as shown in FIG. 9.

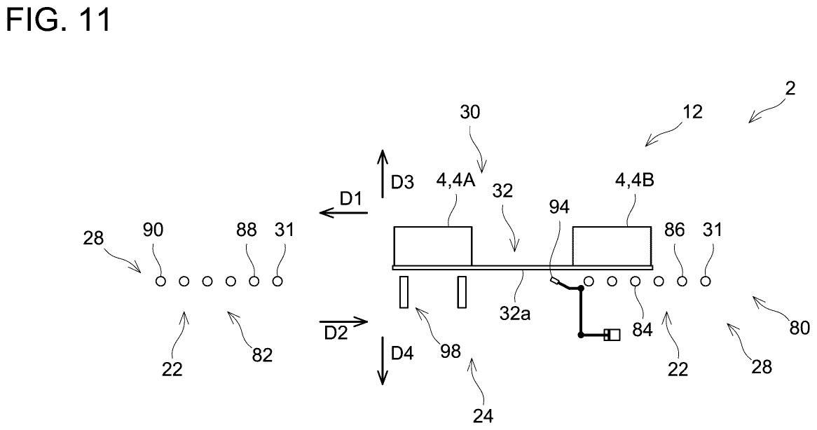

Then, as shown in FIG. 11, the moving device 32 (i.e., the beams 32a) moves in the up direction D3 from its initial position. As the beams 32a elevate higher than upper ends of the stand 98 and the first upstream roller conveyor 84, the saggar 4A is placed on the beams 32a and separated apart from the stand 98, and the saggar 4B is placed on the beams 32a and separated apart from the first upstream roller conveyor 84.

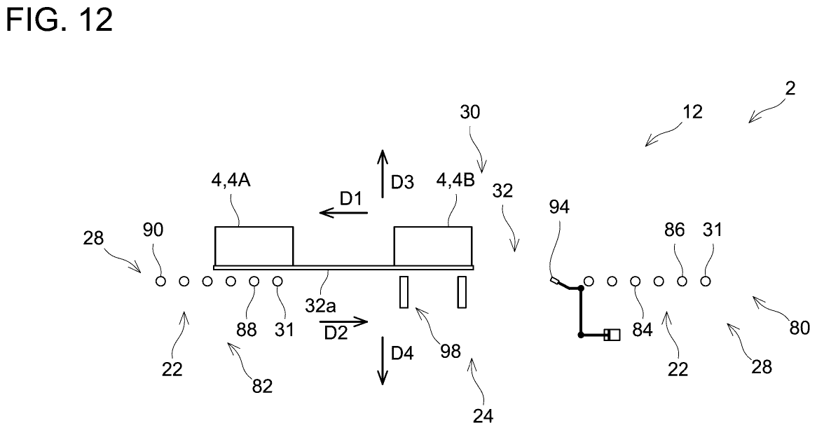

Then, as shown in FIG. 12, the beams 32a move in the conveying direction D1 so that front portions of the beams 32a are positioned directly above the first downstream roller conveyor 88 and rear portions of the beams 32a are positioned directly above the stand 98. This movement of the beams 32a in the conveying direction D1 allows the saggar 4A and the saggar 4B to move simultaneously in the conveying direction D1 while a distance between the saggars 4A and 4B in the conveying direction D1 is maintained at a predetermined distance (i.e., with the saggars 4A and 4B spaced apart from each other). Further, the saggar 4B is distanced from a following saggar 4 (i.e., a saggar 4 on the upstream roller conveyor 80). Since the saggar 4B can be distanced from a following saggar 4 at the same time the saggar 4A is moved from the stand 98, the time required to convey the saggars 4A and 4B is reduced as compared to a configuration in which the saggars 4A and 4B are conveyed separately. Further, changes in the orientations of the saggars 4A and 4B are suppressed during the conveyance. Moreover, changes in the distance between the saggars 4A and 4B are suppressed during the conveyance. Furthermore, the speed of the beams 32a conveying the saggars 4A and 4B is faster than the speed of the rollers conveying them.

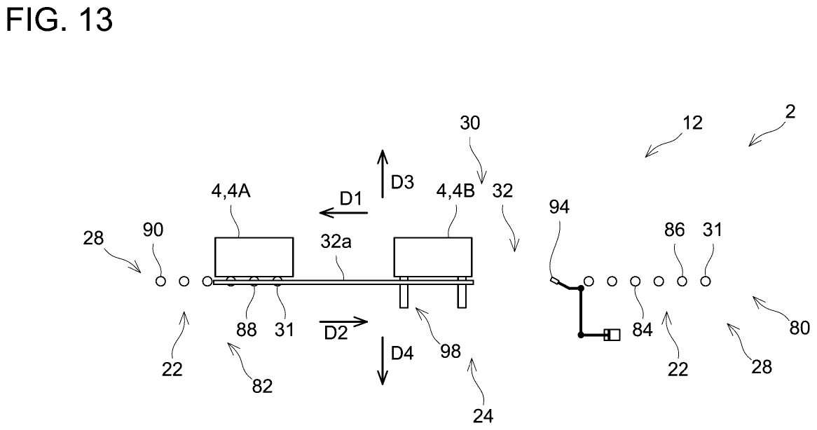

Then, as shown in FIG. 13, the beams 32a move in the down direction D4. As the beams 32a descend below upper ends of the first downstream roller conveyor 88 and the stand 98, the saggar 4A is placed on the first downstream roller conveyor 88 and separated from the beams 32a, and the saggar 4B is placed on the stand 98 and separated from the beams 32a. Thereafter, the saggar 4A on the first downstream roller conveyor 88 is moved from the first downstream roller conveyor 88 to the second downstream roller conveyor 90 by the rotation of the rollers 31. Further, since the orientation of the saggar 4B does not change during the conveyance by the beams 32a, the saggar 4B is processed by the processing device 56 (see FIG. 10) without its orientation being adjusted on the stand 98.

Then, as shown in FIG. 7, the beams 32a move in the backward direction D2. The beams 32a thus return to its initial position. The saggars 4 are conveyed sequentially by the beams 32a moving in the up direction D3, conveying direction D1, the down direction D4, and the backward direction D2 in this order.

### (Effects)

In the embodiment above, the saggars 4A and 4B are conveyed in the conveying direction D1 by the two beams (bars) 32a of the moving device 32. In this configuration, the orientations of the saggars 4A and 4B do not change during the conveyance. Thus, there is no need to adjust the orientations of the saggars 4A and 4B after the conveyance of the saggars 4A and 4B. Further, since the saggars 4A and 4B are conveyed by the two beams (bars) 32a, the distance between the saggars 4A and 4B is maintained. Moreover, the speed of the beams 32a conveying the saggars 4A and 4B is faster than the speed of the rollers 31 conveying them. Therefore, the time required to convey the saggars 4A and 4B can be reduced.

### Second Embodiment

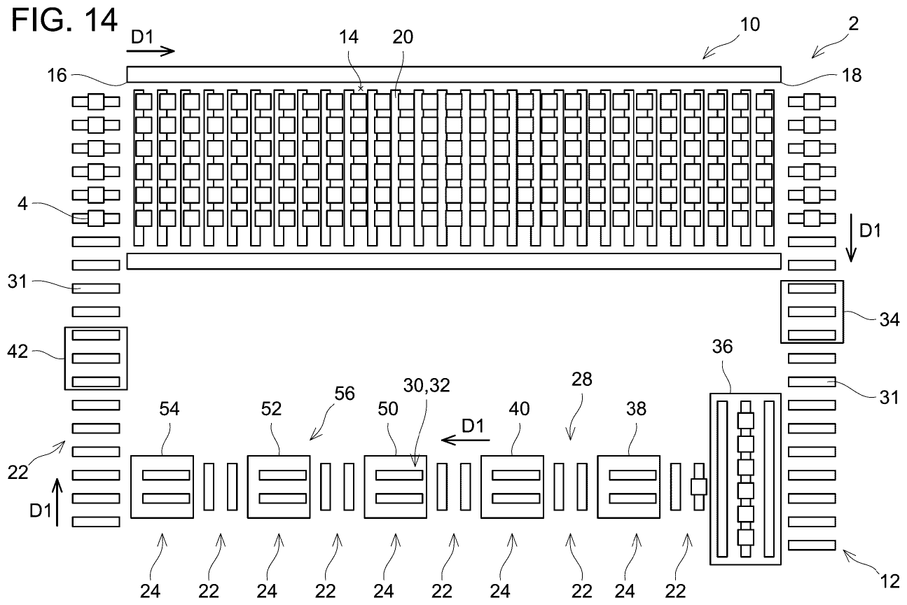

Referring to FIG. 14, a second embodiment is described. For the second embodiment, only differences from the first embodiment are described. As shown in FIG. 14, the disintegrating device 38 and the recovery device 40 are positioned in second sections 24. A first section 22 is positioned between the second section 24 in which the disintegrating device 38 is positioned and the second section in which the recovery device 40 is positioned. A saggar 4 to be processed by the disintegrating device 38 is conveyed by a moving device 32 (beams 32a or bars 32a), while a saggar 4 to be processed by the recovery device 40 is conveyed by another moving device 32 (beams 32a or bars 32a). The saggars 4 are conveyed by the corresponding moving devices 32 from the upper roller conveyors 80 (see FIG. 7) onto the stands 98 (see FIG. 7), processed by the disintegrating device 38 and the recovery device 40, and then conveyed from the stands 98 onto the downstream roller conveyors 82. Thus, there is no need to adjust the orientations of the saggars 4 on the stands 98. Further, saggars 4B are separated from the following saggars 4 (i.e., saggars 4 on the upstream roller conveyors 80). Since the saggars 4B can be separated from the following saggars 4 at the same time the saggars 4A are moved from the stands 98, the time required to convey the saggars 4A and 4B can be reduced.

### (Variants)

In one embodiment, each first conveying device 28 may convey the saggars 4 by one or more chains.

In one embodiment, each moving device 32 may convey three or more saggars 4 simultaneously.

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A heat treatment system comprising:
a heat treatment furnace including an entrance, an exit, and an internal space in which a plurality of saggars is conveyed from the entrance to the exit; and
a return line located outside the heat treatment furnace and configured to convey the plurality of saggars from the exit to the entrance;
wherein
the return line comprises:
a first conveying device located in a first section and configured to convey the plurality of saggars; and
a second conveying device located in a second section different from the first section and configured to convey the plurality of saggars by a beam or a bar.

2. The heat treatment system according to claim 1, further comprising a processing device located in the second section and configured to process saggars being conveyed by the second conveying device,
wherein the second conveying device comprises a moving device configured to:
allow the plurality of saggars aligned in a conveying direction to be placed thereon, and
be movable in the conveying direction, in a backward direction opposite to the conveying direction, in an up direction perpendicular to the conveying direction, and in a down direction opposite to the up direction.

3. The heat treatment system according to claim 2, further comprising a stand on which a saggar to be processed by the processing device is placed,
wherein the moving device is configured to move the saggar onto the stand when moving in the conveying direction, the up direction, and the down direction.

4. The heat treatment system according to claim 3, wherein
the first conveying device comprises:
an upstream conveyor located upstream of the second conveying device on the return line; and
a downstream conveyor located downstream of the second conveying device on the return line, and
the moving device is configured to move a saggar conveyed on the upstream conveyor onto the stand and move the saggar on the stand to the downstream conveyor when moving in the conveying direction, the up direction, and the down direction.

5. The heat treatment system according to claim 4, further comprising an orientation adjusting device configured to adjust orientations of the saggars on the upstream conveyor.

6. The heat treatment system according to claim 2, wherein the processing device is selected from a group consisting of: a cleaning device configured to clean the saggars, a filling device configured to fill the saggars with a material, and a surface smoothing device configured to smooth a surface of a material in the saggars.
